(19) United States
(12) Patent Application Publication
(10) Pub. No.: US 2009/0264165 A1
(43) Pub. Date: Oct. 22, 2009

(54) MOBILE TERMINAL

(75) Inventors: Koji Hakamata, Shizuoka (JP); Hidekazu Kano, Kanagawa (JP)

Correspondence Address: Christensen O'Connor Johnson Kindness PLLC, 1420 Fifth Avenue, Suite 2800, Seattle, WA, 98101-2347, US

(73) Assignee: Panasonic Corporation, Osaka (JP)

(21) Appl. No.: 12/418,348

(22) Filed: Apr. 3, 2009

(30) Foreign Application Priority Data
Apr. 18, 2008 (JP) 2008-108920

(51) Int. Cl. H04M 1/00

(52) U.S. Cl. 455/575.1

(57) ABSTRACT

A mobile terminal includes a case, a planar member configured as a part of the case, a touch panel provided on the case in substantially parallel with the planar member and having a predetermined light transmittance, and a sheet detachably attached between the planar member and the touch panel.

### BACKGROUND

The present invention relates to a mobile terminal to which an inputting operation is applied through a touch panel.

Up to now, mobile terminals such as a cellular phone, a PDA (Personal Digital Assistance), a hand-held game machine, and the like, to which an inputting operation is applied through a touch panel, have been developed and put on the market. All the mobile terminals are constructed such that a display device such as LCD (Liquid Crystal Display), or the like is arranged under a transparent touch panel and necessary input keys are displayed on the LCD in response to an application (see Patent Literature 1 and Patent Literature 2, for example).

Also, as for a part of cellular phones, the maker is selling case covers called “Custom Jacket” (registered trademark), on which various designs are executed respectively, as the optional part. The user can buy a case cover out of them according to user's own liking and exchange the case cover mutually.

### [Patent Literature 1] JP-A-2006-311224

### [Patent Literature 2] JP-A-2002-229719

However, in the mobile terminal set forth in Patent Literature 1 and Patent Literature 2, the display device such as LCD, or the like is needed under the touch panel. Therefore, a size, particularly a thickness, of the mobile terminal is increased. Also, a weight or a cost is increased because of the presence of the display device. Further, such a problem exists that software for displaying the input keys necessary for the operation must be developed and installed into the display device. Also, a wide variety of different designs are prepared for “Custom Jacket” (registered trademark), nevertheless these case covers are designed on the maker side in the end. As a result, the user individual cannot freely design the user's own case cover yet.

### SUMMARY

It is therefore an object of the present invention to provide a mobile terminal in which the design of the key operating portion can be freely changed by exchanging a sheet.

In order to achieve the above object, according to the present invention, there is provided a mobile terminal of the present invention, comprising:

a case;

a planar member configured as a part of the case;

a touch panel provided on the case in substantially parallel with the planar member and having a predetermined light transmittance; and

a sheet detachably attached between the planar member and the touch panel.

According to this configuration, even though the display device such as LCD, or the like and the display controlling software are not provided, the user can apply the inputting operation to the touch panel based on the mode (design) of the sheet. Also, since the touch panel is transparent over the almost full surface, the user can see through to the underlying space. Also, the user can change freely the design of the key operating portion by exchanging the sheet.

Also, in the mobile terminal of the present invention, operation keys are depicted on the touch panel.

Also, in the mobile terminal of the present invention, operation keys are depicted on the sheet.

Also, in the mobile terminal of the present invention, an electric wiring is provided in the sheet, and the mobile terminal further includes a control circuit provided in the case and has an input port connected to the electric wiring.

According to this configuration, the user can discriminate whether or not the sheet is present, by monitoring a state of the input port. Therefore, the user can change the operation of the mobile terminal given by the predetermined key inputting operation, in response whether or not the sheet is present.

Also, in the mobile terminal of the present invention, the control circuit accepts inputs from predetermined operation keys of the touch panel when the electric wiring is connected to the input port, and does not accept the predetermined operation keys when the electric wiring is not connected to the input port.

According to this configuration, the user can switch the function allocated to the predetermined operation key, in response whether or not the sheet is inserted.

Also, the mobile terminal of the present invention further includes an illumination light source provided in the case, and the sheet has a light translucency and receives a light emergent from the illumination light source.

According to this configuration, when the user turns on the illumination light source, such user can perceive the touch panel, the operation keys depicted on the sheet, etc. even in a dark place, and can operate the mobile terminal.

Also, when the operation keys indicated on the sheet and the touch panel are depicted with a fluorescent paint, visibility in a dark place and operability can be improved.

As described above, in the mobile terminal to which the inputting operation is applied through the touch panel, the present invention has such a convenience that the user can change freely the design of the key operation portion, and also possesses such advantages that a size reduction, a reduction in thickness, a weight reduction, and a reduction in cost can be achieved rather than the prior art, by reducing the display device such as LCD, or the like.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a view showing a mobile terminal according to an embodiment of the present invention and an example of a key sheet that a user inserts;

FIG. 2 is a view showing a state of the mobile terminal shown in FIG. 1 after the key sheet is inserted;

FIG. 3 is a sectional view of the mobile terminal according to the embodiment of the present invention;

FIG. 4 is a view showing a mobile terminal according to another embodiment of the present invention;

FIG. 5 is a view showing an example of a key sheet according to another embodiment of the present invention;

FIG. 6 is a view showing an example of a key sheet type discriminating circuit (normal type); and

FIG. 7 is a view showing an example of a key sheet type discriminating circuit (high-performance type).

### DETAILED DESCRIPTION OF EXEMPLARY EMBODIMENTS

A mobile terminal according to an embodiment of the present invention will be explained with reference to the drawings hereinafter.

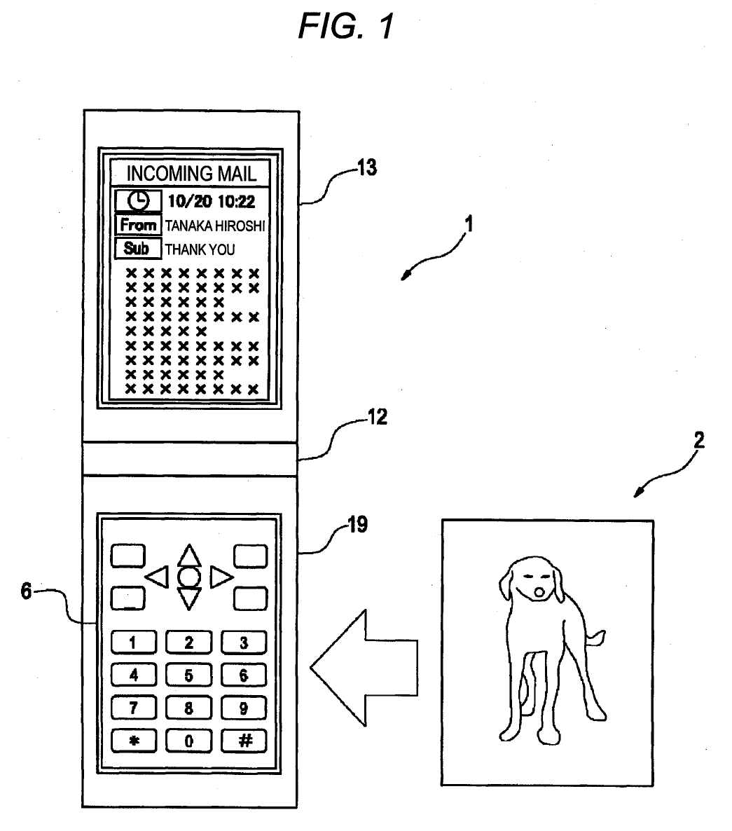

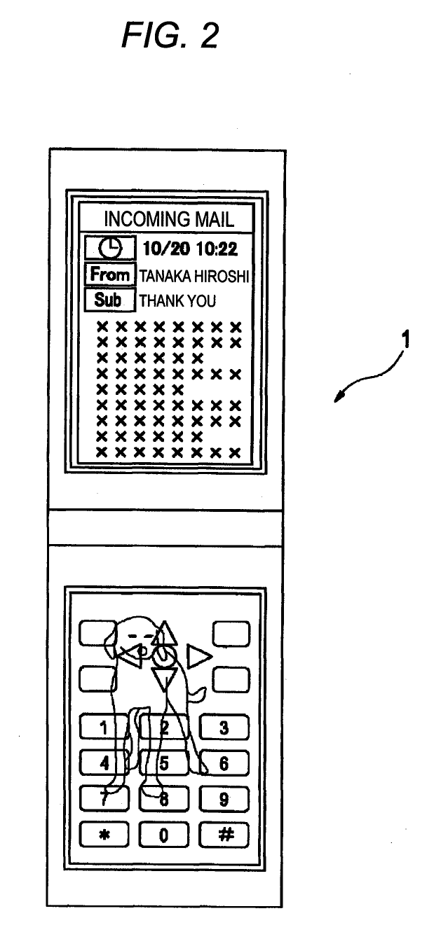

FIG. 1 and FIG. 2 show a cellular phone as a mobile terminal according to an embodiment of the present invention. In the cellular phone of the present embodiment, a user can change freely a design of a key operating portion. As shown in FIG. 1, a cellular phone 1 of the present embodiment is constructed by connecting an upper case 13 and a lower case 19 turnably (foldably) by a hinge 12. Also, as described later, this cellular phone is constructed such that a key sheet (sheet) 2 on which any photos, pictures, characters, etc. are drawn according to user's own liking can be inserted/removed into/from the lower case 19.

FIG. 2 is a view showing a state of the mobile terminal shown in FIG. 1 after the key sheet is inserted into the key operating portion. As an example, the case where a photo of a dog that the user keeps as a pet is inserted is assumed.

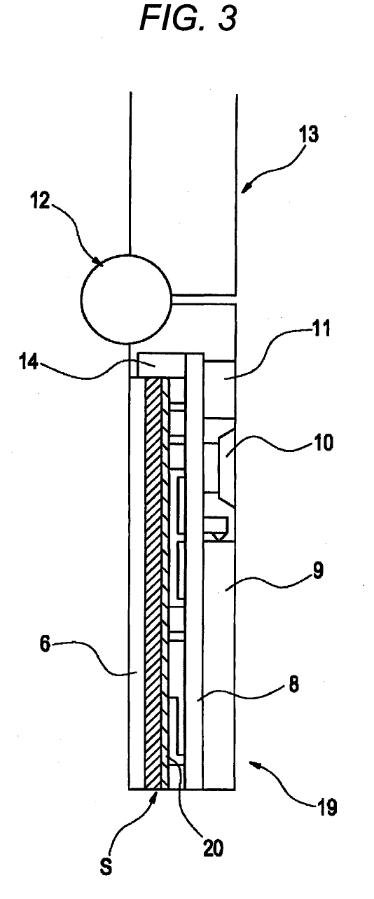

FIG. 3 shows a sectional view of the cellular phone 1 shown in FIG. 1, particularly a sectional view of the lower case 19 containing the key operating portion. The lower case 19 has a planar member 20 serving as a part of the lower case 19 and having an almost planar shape, a touch panel 6, a substrate 8, a battery 9, a speaker 10, a camera 11, and an illumination light source 14 such as an LED, or the like. Also, S denotes a clearance (space) that is defined between the touch panel 6 and the planar member 20. The clearance S has a shape and a dimension that allow an insertion of the key sheet 2.

In the cellular phone of the present embodiment, the touch panel 6 is inserted into the lower case 19. Normally the touch panel 6 is formed of transparent material. The cellular phone of the present invention is also equipped with the touch panel 6 that is formed of such transparent material. Also, operation keys needed to operate the cellular phone are depicted on the touch panel 6. As the method of depicting the operation keys on the touch panel 6, there are various methods such as the method of printing directly translucent lines, etc. on the touch panel, the method of pasting a transparent film, or the like on which the operation keys, etc. are printed, and others. But the method of depicting the operation keys is not particularly restricted.

Also, as shown in the sectional view in FIG. 3, the touch panel 6, the clearance S, the planar member 20, the substrate 8, and the battery 9 are arranged sequentially from the key operating surface toward the back surface. Also, the speaker 10 and the camera 11 are arranged between the substrate 8 and the back surface to align with the battery 9. The user can insert the key sheet 2, on which any photos or pictures are depicted, into the clearance S, or cannot insert such key sheet 2. In case the key sheet 2 is inserted into the clearance S, when the user presses the touch panel, a force produced by the pressing is transferred from the touch panel 6 to the planar member 20 via the key sheet 2, and then the planar member 20 as a part of the lower case 19 receives the pressing force. In contrast, in case the key sheet 2 is not inserted into the clearance S, when the user presses the touch panel, the touch panel 6 is bent by the pressing, and then the touch panel 6 directly contacts the planar member 20. Therefore, the force produced by the pressing is transferred directly from the touch panel 6 to the planar member 20, and then the planar member 20 as a part of the lower case 19 receives the pressing force. According to this configuration, the lower case 19 can receive the force produced by the user's pressing independently of whether or not the key sheet 2 is present in the clearance S.

In addition, when the key sheet 2 inserted into the clearance S is changed according to the user's liking based on this configuration, the user can change originally a design of the key operating portion, as shown in FIG. 2. Also, as described above, the keys necessary for the operation are depicted in advance on the touch panel 6. Therefore, unless the key sheet 2 is inserted into the clearance S, the user can discriminate respective operation keys.

According to the present invention, the sheet on which necessary information such as the operation keys, etc. are marked-is-arranged under the touch panel. Therefore, it is not necessary to install the display device such as LCD, or the like and controlling software of the display device into the mobile terminal. As a result, the slimming down of the mobile terminal can be achieved. Also, when the user exchanges the sheet for user's self, such user can change easily the design of the key operating portion according to user's liking.

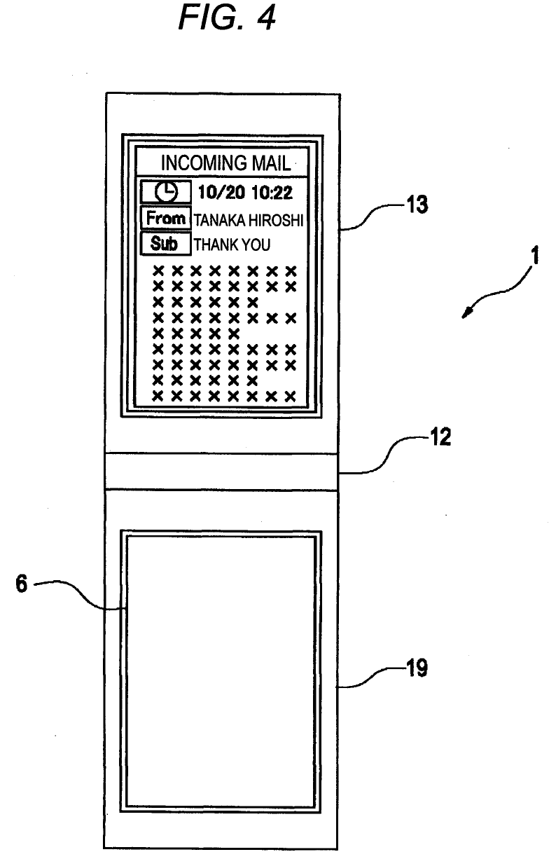

FIG. 4 shows the mobile terminal 1 according to another embodiment. In the mobile terminal 1 of the present embodiment, no operation key is depicted on the touch panel.

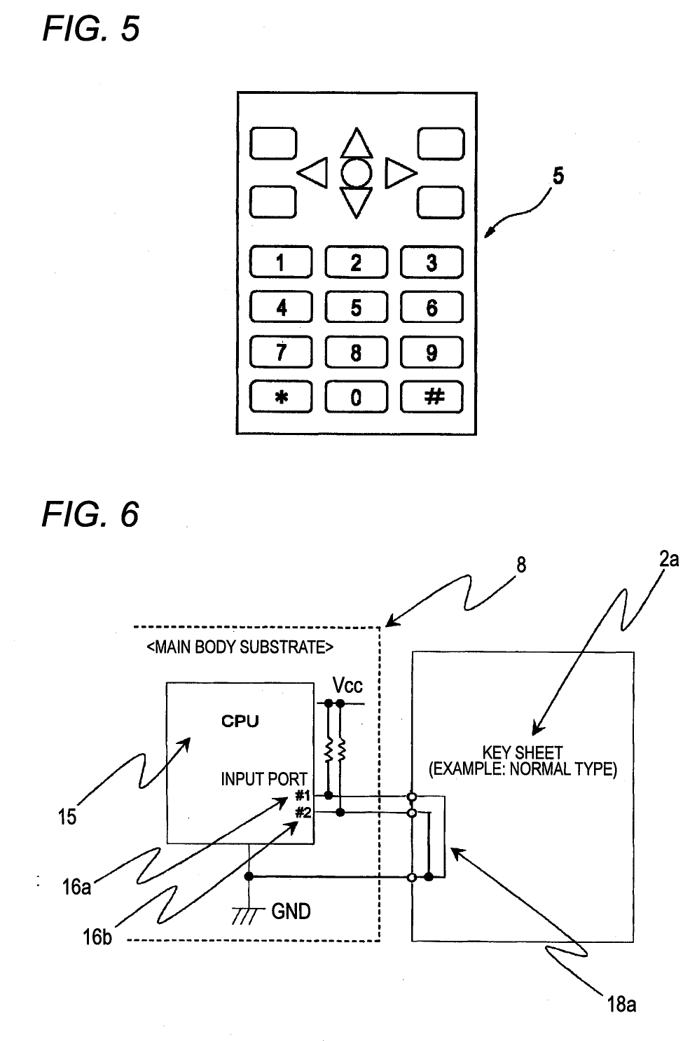

FIG. 5 is a view showing the sheet to be inserted into the key operating portion, in the present embodiment. In this example, a key sheet 5 on which a key arrangement of the common cellular phone is used. A sectional structure of the lower case 19 of the cellular phone 1 in the present embodiment is similar to that of in the first embodiment shown in FIG. 3, and the key sheet 5 in FIG. 6 is inserted into the clearance S. In this event, the key sheet 5 can be inserted into the clearance S and can be removed from the clearance S, and any material may be employed if the operation keys can be depicted thereon.

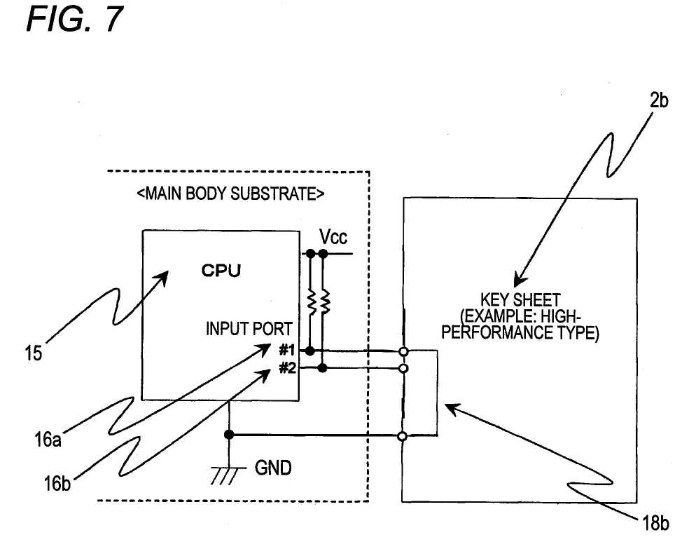

Next, a system for detecting whether the key sheet is attached or detached and a system for discriminating the key sheet type will be explained with reference to FIG. 6 and FIG. 7 hereunder. Following systems are applicable to the cellular phone in both embodiments in FIG. 1 and FIG. 4.

FIG. 6 is a view showing a configuration of a discriminating circuit for discriminating the type of a key sheet 2a that is inserted, particularly shows a circuit used when the key sheet 2a corresponds to a normal type key sheet. A CPU (Central Processing-Unit) 15 as a controlling circuit and input ports 16a, 16b of the CPU 15 are formed on the substrate 8, and thus the discriminating circuit is constructed. Key sheet internal wirings (electric wirings) 18a that denote the normal type key sheet are built in the key sheet 2a.

FIG. 7 is a view showing a configuration of a discriminating circuit for discriminating the type of a key sheet 2b that is inserted, particularly shows a circuit used when the key sheet 2b corresponds to a high-performance type key sheet like the present embodiment. The CPU (Central Processing Unit) 15 as the controlling circuit and the input ports 16a, 16b of the CPU 15 are formed on the substrate 8, and thus the discriminating circuit is constructed. Key sheet internal wirings (electric wirings) 18b that denote the high-performance type key sheet are built in the key sheet 2b.

Next, an operation of the CPU 15 to discriminate whether or not the normal type key sheet is connected will be explained with reference to FIG. 6 hereunder. The input ports 16a, 16b are connected to a power supply voltage (Vcc) via a resistor respectively. When the key sheet 2a is not connected to the substrate 8 (not shown), the power supply voltage (Vcc) is input into the input ports 16a, 16b of the CPU 15. Then, as shown in FIG. 6, when the key sheet 2a is connected to the substrate 8, two input ports 16a, 16b of the CPU 1115 mounted on the substrate 8 are connected to a ground (GND) of a cellular phone main body via the wiring 18a in the key sheet 2. Accordingly, a ground voltage is input into the input ports 16a, 16b.

Here, the internal wiring 18a is the wiring peculiar to the normal type key sheet, and this wiring brings the input ports 16a, 16b into the ground voltage. Accordingly, the CPU 15 discriminates that the normal type key sheet is connected, based on the event that the input ports 16a, 16b are brought into the ground voltage. Also, the operation keys for the common cellular phone are depicted on the key sheet 2a.

Next, an operation of the CPU 15 to discriminate whether or not the high-performance type key sheet is connected will be explained with reference to FIG. 7 hereunder. When the key sheet 2b is not connected to the substrate 8, the power supply voltage (Vcc) is input into the input ports 16a, 16b of the CPU 15, like the above. Then, as shown in FIG. 7, when the key sheet 2b is connected to the substrate 8, the input port 16a of the CPU 15 mounted on the substrate 8 is connected to the ground (GND) of the cellular phone main body via the wiring 18b in the key sheet 2. In contrast, the wiring 18b corresponding to the input port 16b is not provided. Accordingly, the ground voltage is input into the input port 16a, and the power supply voltage is input into the input port 16b.

Here, the internal wiring 18b is the wiring peculiar to the high-performance type key sheet, and this wiring brings the input port 16a into the ground voltage and brings the input port 16b into the power supply voltage. Accordingly, the CPU 15 discriminates that the high-performance type key sheet is connected, based on the event that the input ports 16a and 16b are brought into the ground voltage and the power supply voltage respectively. Also, the operation keys for the high-performance cellular phone are depicted on the key sheet 2b.

According to the configurations in FIG. 6 and FIG. 7, the CPU 15 monitors whether or not the input ports 16a, 16b are connected to the electric wirings (internal wirings) 18a, 18b of the key sheet, i.e., states of the input ports 16a, 16b; so that the CPU 15 can discriminate whether or not the key sheet is present. For example, when the key sheet is not inserted into the mobile terminal 1, the CPU 15 can control the mobile terminal such that either all input operations applied to the operation keys of the terminal main body are made invalid or only the input operations applied to predetermined operation keys are made invalid.

Also, as in the key sheet 2a and the key sheet 2b, when the internal wiring is changed in response to the type of the key sheet like the internal wiring 18a and the internal wiring 18b, the CPU 15 can read the voltage value of the input ports 16a, 16b as the 2-bit variation. Thus, the CPU 15 can discriminate whether or the key sheet is inserted and also the type of the inserted key sheet.

In this manner, the CPU 15 can discriminate the type of the key sheet. Therefore, if the cellular phone operating method and other functions are prepared in plural previously every type of the key sheet, the CPU 15 can change the operating method among a plurality of operating methods prepared in advance, and the like, based on the discriminated result of the type of the key sheet. Also, the operating methods, etc. can be implemented by the software executed by the CPU 15. Therefore, respective functions of the operating methods, etc. can be changed by changing this software.

Here, not only the above types such as the “normal type” and the “high-performance type” but also various key types, e.g., screen specification type such as “vertically oriented screen operation type” or “horizontally oriented screen operation type”, type such as “simple operation type” for the elderly person, type such as “function specific type”, and others, can be set as the key type. Also, when the key sheets are prepared in advance to simulate key placements that are set differently every maker and every: communication company respectively, user's inconvenience in operating the mobile terminal, i.e., user's confusion caused due to difference in the key placement and the operating method, can be reduced in such a situation that the user buys a new mobile terminal whose maker or whose communication company is different from the present one.

In the above embodiment, as the input ports 16a, 16b used to discriminate the key type and the internal wirings 18a, 18b of the key sheet, two wirings are provided respectively. But the number of wirings may be increased in answer to the number of assumed key types.

In this case, when the key sheet is not inserted, the user cannot specify the function assigned to the key input position even though the user can specify this position on the touch panel. As a result, it is feared that an error in an operation of the mobile terminal is caused. Therefore, the mobile terminal can be controlled such a way that, when the key sheet is not inserted, all key input operations are made invalid. Alternately, the mobile terminal may be controlled such a way that all key input operations are made valid but the particular function is made valid by pressing any key and remaining functions are made invalid. For example, in the case of the cellular phone, when only the function of “answering the incoming call” can be activated and remaining functions are made invalid, not only the above error in the operation can be prevented but also such a disadvantage can be prevented that the user cannot answer the phone from on the other end.

In the present embodiment, the key sheet is formed of a flat-plate like resin that is used widely as a backlight translucent plate of the LCD and has a light translucency, or the like. Also, the illumination light source 14 such as LED, or the like is arranged on the substrate 8 to input a light into the key sheet, and this LED is turned on (ON) at a time of input operation. Thus, the user can recognize the keys depicted on the key sheet even in a dark place, and can operate the keys. In addition, when the keys are depicted or printed with a fluorescent paint, visibility in a dark place can be enhanced further and operability can be improved.

As explained above, in the mobile terminal according to the embodiment of the present invention, the clearance into which the sheet can be inserted is provided at the back of the touch panel. Therefore, the display device such as LCD, or the like needed under the conventional touch panel can be eliminated, and also the user can change freely the design of the key operating surface by replacing the sheet having the different picture, photo, or the like. Also, the type of the inserted key sheet is discriminated automatically by using the CPU and its input ports and the internal wirings 18 of the sheet, and the operability of the terminal and the application can be changed automatically in answer to the type of the key sheet. As a result, the mobile terminal having high versatility and high convenience that allows the user's operation in a dark place can be provided.

With the above, various embodiments of the present invention are explained. But the present invention is not restricted to the matters disclosed in the above embodiments. Variations and modifications made by those skilled in the art based on the description of the specification and the well known technologies belong to anticipation of the present invention, and are contained in a scope within which protection is sought.

As described above, the present invention gives room for change of design to the user of a mobile terminal equipped with a touch panel, and is useful in downsizing a mobile terminal.

The present application is based on Japanese Patent Application No. 2008-108920 filed on Apr. 17, 2008, the contents of which are incorporated herein for reference.

What is claimed is:

1. A mobile terminal, comprising:
a case;
a planar member configured as a part of the case;
a touch panel provided on the case in substantially parallel with the planar member and having a predetermined light transmittance; and
a sheet detachably attached between the planar member and the touch panel.

2. The mobile terminal according to claim 1, wherein operation keys are depicted on the touch panel.

3. The mobile terminal according to claim 1, wherein operation keys are depicted on the sheet.

4. The mobile terminal according to claim 1, wherein an electric wiring is provided in the sheet, and
the mobile terminal further comprising:
a control circuit provided in the case and having an input port connected to the electric wiring.

5. The mobile terminal according to claim 4, wherein the control circuit accepts an input from predetermined operation keys of the touch panel when the electric wiring is connected to the input port, and does not accept the predetermined operation keys when the electric wiring is not connected to the input port.

6. The mobile terminal according to claim 1, further comprising:
an illumination light source provided in the case,
wherein the sheet has a light translucency and receives a light emitting from the illumination light source.
